(19) United States
(12) Patent Application Publication
(10) Pub. No.: US 2009/0133125 A1
(43) Pub. Date: May 21, 2009

(54) METHOD AND APPARATUS FOR MALWARE DETECTION

(76) Inventors: Yang Seo Choi, Daejeon (KR); Ik Kyun Kim, Daejeon (KR); Byoung Koo Kim, Daejeon (KR); Seung Yong Yoon, Daejeon (KR); Dae Won Kim, Daejeon (KR); Jin Tae Oh, Daejeon (KR); Jong Soo Jang, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/209,249

(22) Filed: Sep. 12, 2008

(30) Foreign Application Priority Data
Nov. 21, 2007 (KR) 10-2007-0119190

(51) Int. Cl. G06F 21/00

(52) U.S. Cl. 726/24

(57) ABSTRACT

The present invention relates to an apparatus and method for detecting malware. The malware detection apparatus and method of the present invention determines whether a file is malware or not by analyzing the header of an executable file. Since the malware detection apparatus and method can quickly detect presence of malware, it can shorten detection time considerably. The malware detection apparatus and method can also detect even unknown malware as well as known malware to thereby estimate and determine presence of malware. Therefore, it is possible to cope with malware in advance, protect a system with a program, and increase security level remarkably.

### CROSS-REFERENCE TO RELATED APPLICATION

This application claims the benefit of Korean Application No. 10-2007-0119190, filed on Nov. 21, 2007 in the Korean Intellectual Property Office, the disclosure of which is incorporated herein by reference.

### BACKGROUND OF THE INVENTION

1. Field of the invention

The present invention relates to an apparatus and method for detecting malware; and, more particularly, to a malware detection apparatus and method for estimating whether an executable file is malware by analyzing the header of the executable file and detecting the malware.

This work was supported by the IT R & D program of MIC/IITA [2006-S-042-02, “Development of Signature Generation and Management Technology against Zero-day Attack”].

2. Description of the Related Art

Analyses on recent attacks to communication environments reveal that the types of attacks have changed. In the past, attacks generally generated a great deal of network traffics. However, most of the recent attacks have been made to capture desired information by focusing on specific targets using malware.

Malware is also known as malicious program, malicious software, or malicious code and they collectively refer to executable codes authored for malicious purposes. Malware can be divided into virus, worm virus, and Trojan horse according to whether it has a self-replication ability and whether there are infection targets.

Similar to malware, spyware refers to software that sneaks in a computer of somebody and takes important personal information out of the computer. Since spyware has evolved to capture Internet Protocol (IP) address, frequently visited Uniform Resource Locator (URL), and personal identification (ID) and password as well as the name of a user, people concerns about the possibility that spyware might be used maliciously.

Major symptoms caused by malware include increased network traffic, drop in system performance, file deletion, auto-transmission of email, personal information drain, remote control and so forth and damages increase day by day. Most malicious programs are adopting diverse anti-analysis methods in order to conceal the intention and activity of the malicious programs, even if the malware is detected and analyzed by security specialists.

Since the symptoms and distribution methods of malware become more complicated and intellectual, existing antivirus programs have limitation in detecting and curing diverse malicious programs.

Also, most conventional malware detection apparatuses and methods generate signature as the antivirus specialists analyze detected malware and detects the identical malware by using the signature. However, the conventional malware detection apparatuses and methods cannot detect malware if the malware does not have the exactly same signature as the detected malware, and they cannot cope with unknown malware.

### SUMMARY OF THE INVENTION

The present invention relates to technology for determining whether an executable file is malware by analyzing the header of an executable file, e.g., portable executable (PE) file, based on possible characteristics of malware. An embodiment of the present invention is directed to providing a malware detecting apparatus and method that can quickly detect malware and cope with even unknown malware.

In accordance with an aspect of the present invention, there is provided an apparatus for detecting malware, which includes a header extractor, a file determiner, a header analyzer and a malware determiner. The header extractor extracts a header of an input file, and the file determiner determines whether the input file is an executable file or not. The header analyzer analyzes the extracted header of the file and deciding a probability that the input file is malware based on a determination result of the file determiner. The malware determiner collects determination results of the header analyzer, finally determines whether the input file is malware, and outputs a final determination result.

In accordance with another aspect of the present invention, there is provided a method for detecting malware, in which a header of an input file is analyzed to determine whether the input file is an executable file, and when the input file is an executable file, it is determined whether the input executable file is malware through a plurality of predetermined conditions by analyzing the header of the input file. When the input executable file is determined as malware, a signal corresponding to presence of malware is outputted.

### ADVANTAGEOUS EFFECTS

The malware detection apparatus and method of the present invention can detect malware using the characteristics acquired through analysis of the executable file header of detected malware. Since the malware detection apparatus and method can quickly detect malware, it can shorten detection time considerably. The malware detection apparatus and method can also detect even unknown malware as well as known malware to thereby estimate and determine presence of malware. Therefore, it is possible to cope with malware in advance, protect a system with a program, and increase security level remarkably.

### BRIEF DESCRIPTION OF THE DRAWINGS

FIG. 1 is a block diagram of a malware detection apparatus in accordance with an embodiment of the present invention.

FIG. 2 illustrates a structure of a header of an executable file in accordance with an embodiment of the present invention.

FIG. 3 is a flowchart describing a malware detection method in accordance with an embodiment of the present invention.

FIG. 4 is a flowchart describing a method for determining whether a file is an executable file in a malware detection apparatus in accordance with an embodiment of the present invention.

FIG. 5 is a flowchart illustrating a method for determining whether a file is malware in a malware detection apparatus in accordance with an embodiment of the present invention.

### DETAILED DESCRIPTION OF THE PREFERRED EMBODIMENTS

The advantages, features and aspects of the invention will become apparent from the following description of the embodiments with reference to the accompanying drawings, which is set forth hereinafter.

Malware adopts diverse anti-analysis schemes to prohibit itself from being analyzed. In this case, portable executable (PE) header of the malware has a different form from that created by using a general compiler through a normal method.

When the malware employs an anti-analysis scheme, the position or characteristic of the PE header is changed. This causes the PE header to have characteristics that rarely appear in general executable files. The present invention takes advantage of the characteristics and determines whether an executable file is malware or not.

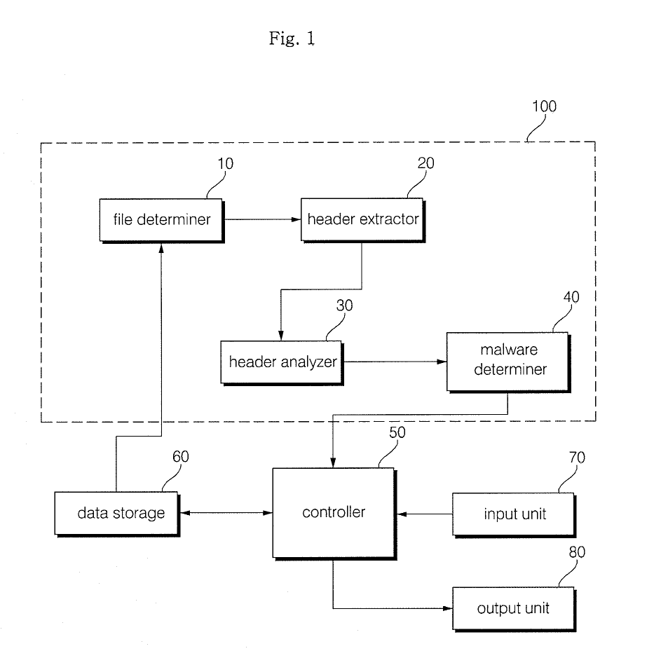

FIG. 1 is a block diagram of a malware detection apparatus in accordance with an embodiment of the present invention.

Referring to FIG. 1, the malware detection apparatus includes a malware detector 100, a data storage 60, a controller 50, an input unit 70, and an output unit 80. The malware detection apparatus may further include an interface for connection to another device or a predetermined network communication module.

The malware detector 100 receives a predetermined file, analyzes the header of the received file, and determines whether the input file is malware based on the analysis result, and outputs the result.

The controller 50 generates a predetermined message corresponding to the result outputted from the malware detector 100, and the output unit 80 outputs the determination result.

The input unit 70 includes a plurality of buttons so that a user can select and input a file to be examined for the probability of being malware among a plurality of files stored in the data storage 60 by manipulating the buttons. The data storage 60 stores a plurality of program data and data produced from the operation of the malware detector 100. Herein, the data storage 60 includes a volatile memory for temporarily storing an executed program and data produced in the middle of process, a non-volatile memory for storing data, or a memory device for storing a great deal of data.

The output unit 80 includes at least one among a display for showing text or image, a light emitting device that is turned on or off or flickers in some cases, such as lamp, and a sound output device for outputting predetermined sound effect in order to output the operation state of the malware detection apparatus. The output unit 80 drives at least one among the display, the light emitting device, and the sound output device according to a control command from the controller 50 to output whether the input executable file is malware or not. For example, it may output a message indicating whether the file is malware on the display, flicker the light emitting device, or output a certain beeping sound.

The malware detector 100 receives a file stored in the data storage 60 or input from outside and determines whether the file is malware according to the manipulation of the input unit 70. The malware detector 100 checks whether the input file is an executable file of a PE format that can be executed in a Windows operating system. If the header structure of the executable file or a data value included in the header of the executable file satisfies a predetermined condition, it determines the input file as malware. The PE format is applied to all files with extender EXE or DLL.

The malware detector 100 includes a file determiner 10, a header extractor 20, a header analyzer 30, and a malware determiner 40.

The file determiner 10 determines whether the input file is an executable file of a PE format, which is a PE file. The file determiner 10 analyzes the header of the input file and determines whether the input file is an executable file based on whether predetermined data exist at a position designated in the header.

When the input file is determined to be an executable file in the file determiner 10, the header extractor 20 additionally extracts a field value of the header used in the header analyzer 30 other than a field value of the header checked out in the file determiner 10.

The header analyzer 30 analyzes the executable file and determines the probability that the file is malware by using the headers and field values of the headers extracted in the file determiner 10 and the header extractor 20. The header analyzer 30 takes advantage of a plurality of field values included in the header related to a section of the executable file, determines whether the respective field values satisfy predetermined conditions, and if there is a section corresponding to each condition, determines that the file is highly likely to be malware. Also, the header analyzer 30 compares a field value of a header related to code with a reference value and determines whether the executable file has a possibility to be malware.

The malware determiner 40 gives a weight to a result of the header analyzer 30, collectively takes the weights into consideration, and finally determines whether the executable file is malware or not. Herein, the weight used in the malware determiner 40 may be modified according to security level or security policy of each system. Since the modification can be made by a user of the malware detection apparatus, further description on it will not be provided herein.

The malware determiner 40 supplies the determination result on whether the input file is malware to the controller 50, which performs control to have the determination result outputted through the output unit 80.

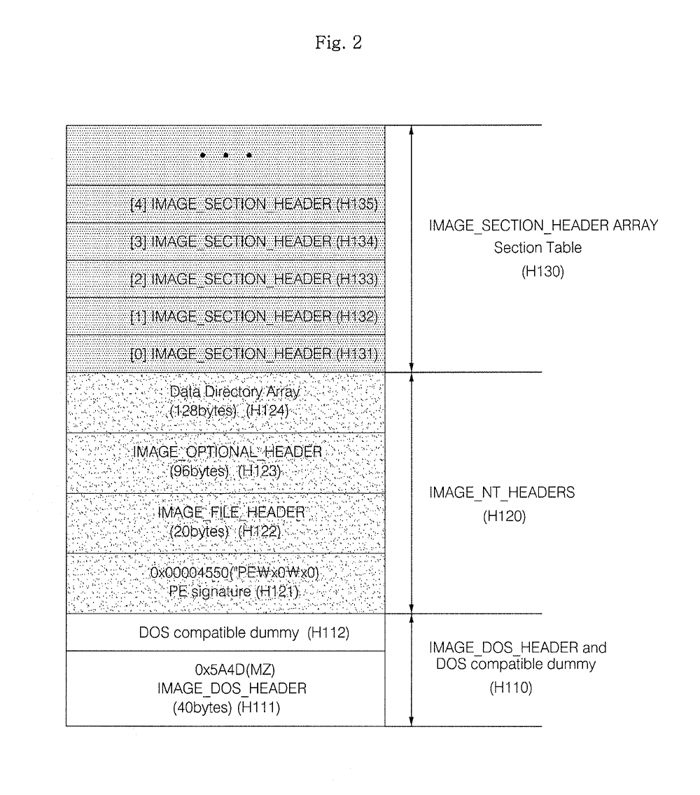

FIG. 2 illustrates a structure of a header of an executable file in accordance with an embodiment of the present invention.

Referring to FIG. 2, the header of the executable file includes a first header (IMAGE_DOS_HEADER) and Disk Operating System (DOS) compatible dummy (H110) which are related to code, a PE header (IMAGE_NT_HEADERS) (H120), and a third header (IMAGE_SECTION_HEADER) and array section table (H130) which are related to a section. The executable file further includes other headers, which will not be described herein.

The header of the executable file includes a region for code and a region for data. When the executable file is actually executed, the regions of the header are loaded onto a memory.

The PE file starts from the first header (IMAGE_DOS_HEADER) (H111) which has a size of 64 bytes and includes fields such as e_magic and e_lfanew. The value of the first field (e_magic) of the first header (H111) is ‘MZ’(0x5A4D). In other words, the header of the PE file starts with ‘MZ.’ The last field of the first header (H111) is the first field (e_lfanew) includes 4-byte data and it includes start offset of the PE header (H120).

In short, when the PE file is executed, it is checked whether the PE file starts with ‘MZ’ and the first header is sequentially executed, and then the checking object is jumped to the PE header (H120) at the position where the data of the first field (e_lfanew), which is the last field of the first header (H111).

Herein, the DOS compatible dummy (H110) following the first header (H111) is a storage for storing error messages to be outputted when Windows program is executed.

After the first header (H111), the PE header (H120) is executed. The PE header (H120) is a structure of IMAGE_NT_HEADERS, and it includes essential information for a PE loader.

A header starts with the PE header (H120), and the PE header (H120) includes 4-byte signature and the subsequent second header (H122), which is 20-byte IMAGE_FILE_HEADER. Also, the PE header (H120) further includes 224-byte IMAGE_OPTIONAL_HEADER (H123) and 128-byte data directory array (H124).

The PE header (H120) includes a PE signature “PE00.” When the system executing the PE file is Windows, the signature of the PE header (H120) should be “PE00.” Otherwise, program is not executed. Accordingly, the malware detection apparatus of the present invention checks whether the signature is “PE00” to see if the PE file is normal.

Herein, the second header (H122) IMAGE_FILE_HEADER includes information on physical layout and properties of the PE file, and the IMAGE_OPTIONAL_HEADER (H123) takes in charge of logical layout.

The second header (IMAGE_FILE_HEADER) (H122) includes information on the type of Central Processing Unit (CPU), time taken for creating a PE file, whether a file is of EXE or DLL, and the number of sections. The second header (H122) includes a Machine field, which is a second field, and a NumberOfSections field.

The Machine field, which is a second field, indicates the type of a system where the file is executed. That is, it indicates the type of CPU. When the value of the Machine field is changed, quick execution of program is interrupted. The NumberOfSections field indicates the number of sections and it is used to forcibly add or delete a section.

Besides, the second header (H122) includes a TimeDateStamp field, which indicates the date, and time when a file is created, and a PointerToSymbolTable field and a NumberOfSymbols field which are required during debugging.

The third header (IMAGE_SECTION_HEADER) (H131 to H135) which is related to section and a section table (H130) includes code on the PE file, data, resources, and other information on the executable file.

Section is a group of information having attributes such as code/data and read/write. Section includes those having the same attributes and there are diverse attributes.

A section table divides sections with a reference line. The section table is an array of IMAGE_SECTION_HEADER structure. Each section includes a header and raw data, and the section table includes only the headers of sections. Herein, the section number is the same as the array size.

The third header (IMAGE_SECTION_HEADER) includes a third field, which is a Characteristic field, indicating whether the extender of the executable file is EXE or DLL, a fourth field, which is a Name field, indicating the name of a section, and a fifth field, which is a SizeOfRawData field, indicating the size of a section.

Since the header of an executable file is formed as shown in FIG. 2, the file determiner 10 determines whether a file is an executable file of a PE format based on the field value included in the first header (IMAGE_DOS_HEADER) (H111) and the second header (IMAGE_FILE_HEADER) (H122).

Herein, the file determiner 10 first checks whether the PE file starts with ‘MZ.’ When the PE file starts with ‘MZ,’ it extracts part of the header of the PE file and checks if there is ‘PE00’ at a predetermined position.

As described above, since a typical PE file has a first header (IMAGE_DOS_HEADER) starting with a DOS signature ‘MZ,’ if an input file does not start with ‘MZ,’ the file determiner 10 determines that the input file is not PE file.

Also, when the header of the PE file starts with ‘MZ,’ the file determiner 10 extracts 64 bytes of the header of the PE file and checks the value of the first field (e_lfanew) of the first header (IMAGE_DOS_HEADER). Herein, if there is no ‘PE00’ at a position corresponding to the value of the first field, it determines that the input file is not a PE file.

Also, when the input file satisfies the two conditions, the file determiner 10 extracts the second header (IMAGE_FILE_HEADER) (H122) and checks the value of the second field (Machine) of the second header (H122), which indicates the type of CPU. When the value of the second field (Machine) is as shown in the following Table 1, the file determiner 10 finally determines that the input file is a PE file.

If the value of the second field (Machine) is not any one of 0X014C, 0X0200 and 0X8664 as shown in Table 1, the file determiner 10 determines that the input file is not a PE file.

TABLE 1

| Definition | Value | Meaning |
|---|---|---|
| IMAGE_FILE_MACHINE_I386 | 0x014c | Intel 386 CPU (32bit) |
| IMAGE_FILE_MACHINE_IA64 | 0x0200 | Intel 386 CPU (64bit) |
| IMAGE_FILE_MACHINE_AMD64 | 0x8664 | AMD64(K8) CPU |

Herein, the value of the second field (Machine) is about the CPU of a system executing the executable file. In case of a 32-bit Intel CPU, the IMAGE_FILE_MACHINE_{—}1386 value of the second field is 0X014C. In case of a 64-bit Intel CPU, the IMAGE_FILE_MACHINE_IA64 value of the second field is 0X0200.

The value of the second field (Machine) used in the file determiner 10 to determine whether an input is a PE file or malware is for limiting the range of determination to systems using CPU. Therefore, the present invention is not limited to it and the values may be added or changed as CPU specification of a system executing a PE file or technology advances.

The header analyzer 30 determines the probability of a PE file being malware by using the field values shown in the following Table 2 among a plurality of field values of headers extracted by the header extractor 20. The header extractor 20 extracts the third header (IMAGE_SECTION_HEADER) related to a section and a data region.

TABLE 2

| Headers | Field Name | Characteristics |
|---|---|---|
| IMAGE_SECTION_HEADER | Characteristics | Characteristics |
| | | of a section |
| IMAGE_SECTION_HEADER | SizeOfRawData | Size of a section |
| IMAGE_SECTION_HEADER | Name | Name of a section |
| IMAGE_DOS_HEADER | e_lfanew | Position of PE |
| | | signature |

The third header (IMAGE_SECTION_HEADER) relates to a section and each field of the third header includes a section-specific value.

The header analyzer 30 takes advantage of the third field (Characteristics) and checks whether there is a section including both executable attribute and write attribute, whether there is a section including any one between executable attribute and code attribute, and whether there is an executable section in the values of the third field.

Also, the header analyzer 30 checks whether there is a section including a value that cannot be printed in the fourth field (Name) value of the third header (IMAGE_SECTION_HEADER), and whether the total sum of the values of the fifth field (SizeOfRawDate) is greater than the entire size of the PE file.

Furthermore, the header analyzer 30 checks whether the first field (e_lfanew) value of the first header (IMAGE_DOS_HEADER) (H122) is smaller than the size of the first header, and whether the first field value of the first header is greater than a predetermined reference.

A section including both executable attribute and write attribute among the sections included in a third field (Characteristics) value is usually used in malware to change a code region while the PE file is executed. Typical PE files do not have such section. Thus, when there is a section including both executable attribute and write attribute in the third field (Characteristics) value, the header analyzer 30 determines that the PE file is highly likely to be malware.

Also, the case when there is a section including any one between executable attribute and code attribute in the third field (Characteristics) value and the case whether there is no executable section in the third field (Characteristics) value are the cases that the author of malware arbitrarily changes the PE file to prohibit the malware from being analyzed. In a typical PE file, a section including an executable attribute among sections included in the third field value also includes a code attribute, too. A typical PE file includes at least one executable section. In short, the third field value of a general PE file includes at least one section including both executable attribute and code attribute.

If there is a section including a value which cannot be printed in the fourth field (Name) value, it is to prohibit a PE file analyzer from easily detecting the start and end of a specific section in malware. In short, it is one of the characteristics of malware for prohibiting a PE file from being analyzed. A general PE file normally generated using a typical compiler does not have such section.

When the total sum of the fifth field (SizeOfRawDate) values is greater than the entire size of the file, it is to set up the size of a specific section large in malware so as to prohibit the PE file from being analyzed by making a malware detection program spend long time to read the malware.

Also, the case that the first field (e_lfanew) value of the first header (IMAGE_DOS_HEADER) (H122) is smaller than the size of the first header cannot occur in general PE files. Thus, this is a case manufactured to prohibit malware from being analyzed.

The case that the first field (e_lfanew) value of the first header (IMAGE_DOS_HEADER) (H122) is greater than a predetermined reference also occurs to prohibit malware from being analyzed. Generally, the PE signature (H121) exists at a position where the IMAGE_DOS_HEADER and DOS compatible dummy end in a PE file.

The header analyzer 30 checks whether the above 7 conditions are satisfied and when at least one of the 7 conditions is satisfied, it determines that the PE file is highly likely to be malware.

The malware determiner 40 determines that the PE file is normal, when all the above 7 conditions are not satisfied in the header analyzer 30. When any one of the 7 conditions is satisfied, it gives a weight to each satisfied condition and determines whether the PE file is malware based on the collective result.

The operation of the malware detection method will be described herein in accordance with an embodiment of the present invention.

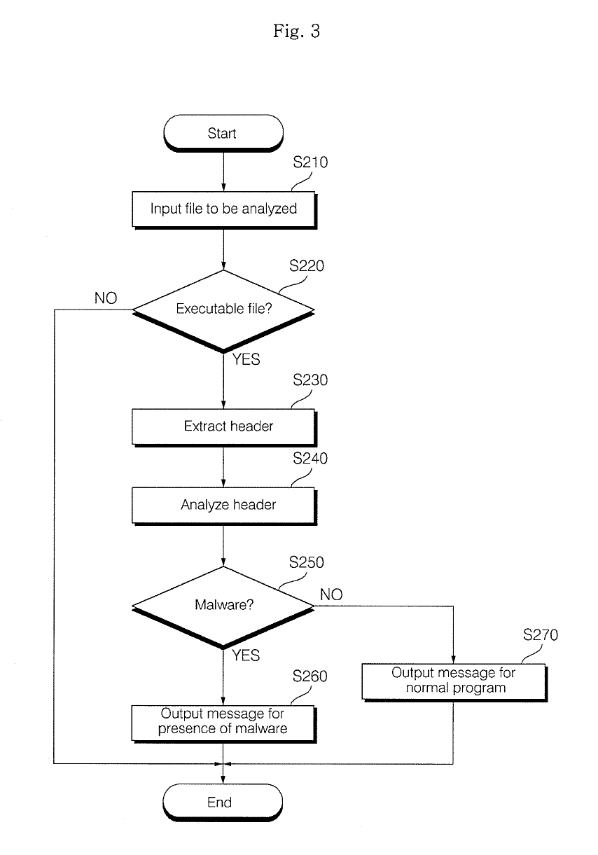

FIG. 3 is a flowchart describing a malware detection method in accordance with an embodiment of the present invention.

Referring to FIG. 3, at step S210, a file to be analyzed is selected and input to the malware detection apparatus through manipulation of the input unit 70. At step S220, the file determiner 10 checks whether the input file is a PE file or not by using headers of the input file.

To determine whether the input file is a PE file or not, the file determiner 10 checks whether the input file starts with a predetermined signature or whether a PE signature indicating that the input file is a PE file is positioned at a predetermined position.

When the file determiner 10 determines that the input file is a PE file, the header extractor 20 additionally extracts a header and provides the extracted header to the header analyzer 30 at step S230. Herein, the header extractor 20 extracts a header to be used in the header analyzer 30 other than a header extracted in the file determiner 10.

At step S240, the header analyzer 30 analyzes the header of the PE file and checks whether an anti-analysis scheme is applied to the header of the PE file to determine the probability that the PE file is malware.

At step S250, the malware determiner 40 gives a weight to the analysis result of the header analyzer 30, finally determines whether the input PE file is malware by collectively estimating weights, and outputs a determination result.

Herein, the controller 50 performs control to output a predetermined message or beeping sound through the output unit 80 based on a determination result of the malware determiner 40. When the input PE file is malware, at step S260, the controller 50 performs control to output a message or beeping sound indicating the presence of malware through the output unit 80.

When it is determined that the PE file is normal, at step S270, a message or a predetermined sound effect indicating that the PE file is normal is outputted through the output unit 80.

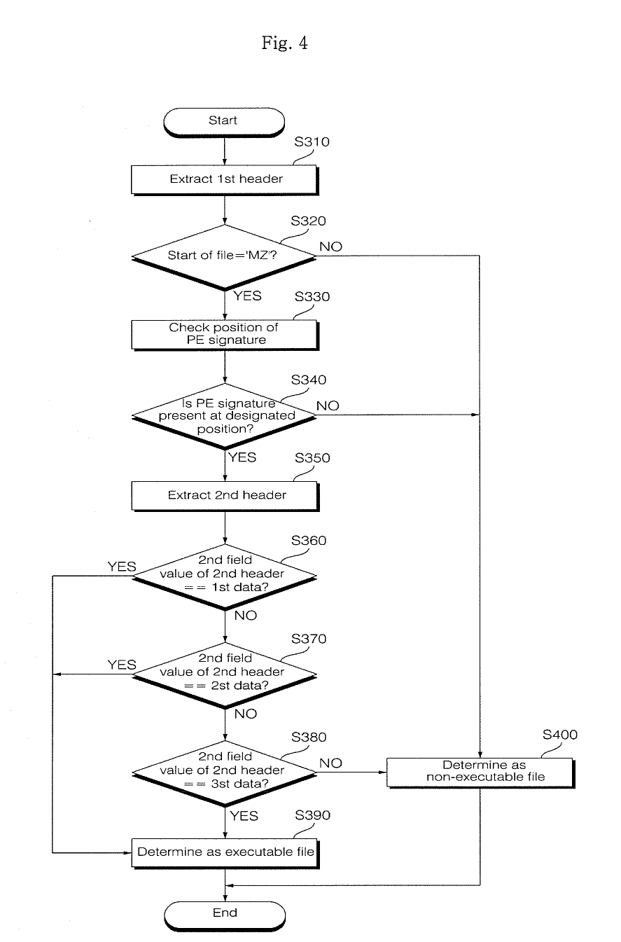

FIG. 4 is a flowchart describing a method for determining whether a file is an executable file in a malware detection apparatus in accordance with an embodiment of the present invention.

Referring to FIG. 4, the file determiner 10 determines whether an input file is a PE file or not based on field values included in the first header (IMAGE_DOS_HEADER) and the second header (IMAGE_FILE_HEADER).

Herein, the file determiner 10 extracts the first header (IMAGE_DOS_HEADER) (H111) at step S310, analyzes the extracted header, and checks whether the header starts with ‘MZ’ at step S320.

When the first header (IMAGE_DOS_HEADER) (H111) starts with ‘MZ’, that is, when the start of the PE file is ‘MZ’, at step S330, the file determiner 10 checks the value of the first field (e_lfanew) and, at step S340, checks whether there is a PE signature (PE00) (h121) at a position corresponding to the value of the first field.

Herein, when the first header does not start with ‘MZ’ and the PE signature is not positioned at the position corresponding to the value of the first field (e_lfanew) but at another position, it determines that the input file is not an executable file of a PE format at step S400.

When the input file starts with ‘MZ’ and the PE signature is positioned at the designated position, at step S350, the header extractor 20 additionally extracts a header to be used in the header analyzer 30. At the step S350, the header extractor 20 extracts the second header (IMAGE_FILE_HEADER) and a section header (IMAGE_SECTION_HEADER) from the structure of the PE header.

At steps S360 to S380, the file determiner 10 compares the value of the second field (Machine) of the second header (IMAGE_FILE_HEADER) for a system specification where the PE file is executed with ‘0X014C’, ‘0X0200’ and ‘0X8664’. Herein, as described above, the second field value has a different value according to a system operating system.

At step S390, when the second field value is matched with at least any one of the codes, the file determiner 10 determines that the input file is an executable file of a PE format. Otherwise, when it is matched with non of the codes, the file determiner 10 determines that the input file is not a PE file at step S400.

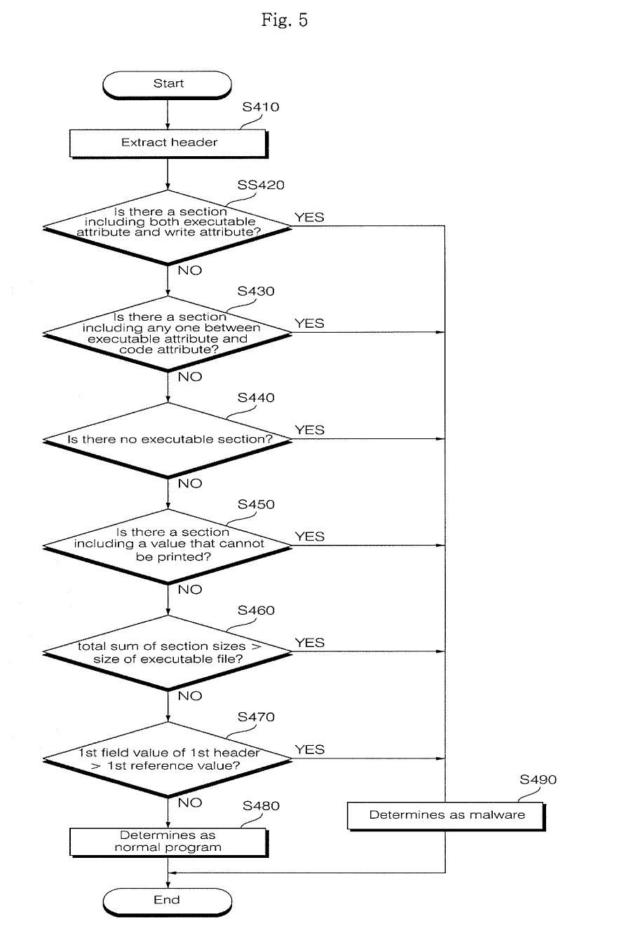

FIG. 5 is a flowchart illustrating a method for determining whether a file is malware in a malware detection apparatus in accordance with an embodiment of the present invention.

Referring to FIG. 5, when the file determiner 10 determines that the input file is an executable file of a PE format, the header analyzer 30 determines the probability that the executable file is malware.

At step S420, the header analyzer 30 checks whether there is a section including both executable attribute and write attribute by using the value of the third field (Characteristics) of the third header (IMAGE_SECTION_HEADER). At step S430, it checks whether there is a section including any one between executable attribute and code attribute. At step S440, it checks whether there is no executable section, that is, whether all included sections are not executable.

Also, the header analyzer 30 checks at step S450 whether there is a section including a value that cannot be printed based on the value of the fourth field (Name) of the third header (IMAGE_SECTION_HEADER). It checks at step S460 whether the total sum of the values of the fifth field (SizeOfRawData) is greater than the entire size of the file. In addition, the header analyzer 30 checks at step S470 whether the value of the first field (e_lfanew) of the first header (IMAGE_DOS_HEADER) (H111) is smaller than the size of the first header (H111) and whether the first field value of the first header is greater than a predetermined reference value.

Whether the above conditions are satisfied is not decided sequentially in the above-described sequence but the sequence for checking the conditions can be changed.

The header analyzer 30 decides the probability that the input file is malware by checking the above conditions, outputs the determination result to the malware determiner 40. The malware determiner 40 give a weight for each decision, and finally determines whether the input file is malware based on collective decision.

Therefore, the malware detection apparatus and method of the present invention analyzes the headers of an executable file, checks whether predetermined conditions are satisfied, and determines whether the executable file is malware or not to thereby cope with new types of malware.

While the malware detection apparatus and method of the present invention has been described with respect to certain preferred embodiments, it will be apparent to those skilled in the art that various changes and modifications may be made without departing from the scope of the invention as defined in the following claims.

What is claimed is:

1. A method for detecting malware, comprising:
determining whether an input file is an executable file or not by analyzing a header of the input file;
determining whether the input file is malware or not through a plurality of predetermined conditions by analyzing the header of the input file if the input file is an executable file; and
outputting a signal corresponding to presence of malware if the input file is determined as malware.

2. The method of claim 1, wherein the determining whether an input file is an executable file or not includes:
determining whether the header of the input file starts with a first signature; and
determining that the input file is an executable file if the header of the input file starts with the first signature and a second signature of the input file is present at a designated position.

3. The method of claim 2, wherein in the determining whether an input file is an executable file or not,
if the header of the input file does not start with the first signature or if the second signature of the input file is not present at a designated position, the input file is determined as an non-executable file and malware detection is terminated.

4. The method of claim 2, wherein the determining whether an input file is an executable file or not further includes:
when the header of the input file starts with the first signature and the second signature of the input file is present at a designated position, extracting a field for a system type from the header of the input file, comparing the field with predetermined data, and determining whether the input file is an executable file based on a comparison result.

5. The method of claim 1, wherein the determining whether the input executable file is malware further includes:
giving weights to the multiple conditions; and
finally determining whether the input file is malware by summing up the weight for the satisfied condition if the input file satisfies at least one of the conditions.

6. The method of claim 1, wherein in the determining whether the input executable file is malware,
if there is a section including both executable attribute and write attribute among sections included in the header of the input file, the input file is determined as malware.

7. The method of claim 1, wherein in the determining whether the input executable file is malware,
if there is a section including any one between executable attribute and code attribute among sections included in the header of the input file, the input file is determined as malware.

8. The method of claim 1, wherein in the determining whether the input executable file is malware,
if there is no executable section among sections included in the header of the input file, the input file is determined as malware.

9. The method of claim 1, wherein in the determining whether the input executable file is malware,
if there is a section including a value that cannot be printed among sections included in the header of the input file, the input file is determined as malware.

10. The method of claim 1, wherein in the determining whether the input executable file is malware,
if a total sum of the sizes of sections included in the input file is greater than the entire size of the file, the input file is determined as malware.

11. The method of claim 1, wherein in the determining whether the input executable file is malware,
if a value directing an end of a first header and a start of a second header among a plurality of headers included in the input file is smaller than the size of the first header, the input file is determined as malware.

12. The method of claim 1, wherein in the determining whether the input executable file is malware,
if a value designating a position of the second signature is greater than a predetermined reference value, the input file is determined as malware.

13. An apparatus for detecting malware, comprising:
a header extractor for extracting a header of an input file;
a file determiner for determining whether the input file is an executable file or not;
a header analyzer for analyzing the extracted header of the file and deciding a probability that the input file is malware based on a determination result of the file determiner; and
a malware determiner for collecting determination results of the header analyzer, finally determining whether the input file is malware, and outputting a final determination result.

14. The apparatus of claim 13, wherein the file determiner determines whether the header of the input file starts with a first signature and a second signature of the input file is present at a designated position to thereby determine whether the input file is an executable file of a Portable Executable (PE) format.

15. The apparatus of claim 13, wherein the header analyzer checks whether there is a section including both executable attribute and write attribute in the header of the input file, whether there is a section including any one between executable attribute and code attribute, whether there is no executable section, whether there is a section including a value that cannot be printed, whether a total sum of the sizes of sections included in the input file is greater than the entire size of the file, whether a value directing an end of a first header and a start of a second header is smaller than the size of the first header, and whether a first field value of the first header is greater than a predetermined reference value; and
if any one of the above conditions is satisfied, the input file is determined as malware.
